(19) United States
(12) Patent Application Publication
(10) Pub. No.: US 2003/0134600 A1
(43) Pub. Date: Jul. 17, 2003

(54) Location device and wireless mulitfuntion key-fob system

(76) Inventors: Stephen J. Picone, Chandler, AZ (US); Regan S. Rhodes, Chandler, AZ (US)

Correspondence Address: Stephen Picone, 1126 W Elliot Rd #2038, Chandler, AZ, 85224, US

(21) Appl. No.: 10/340,337

(22) Filed: Jan. 8, 2003

Related U.S. Application Data
(60) Provisional application No. 60/348,006, filed on Jan. 11, 2002.

(51) Int. Cl. H04B 7/00; H04B 1/00

(52) U.S. Cl. 455/68; 455/66

(57) ABSTRACT

The present invention comprises a key-fob device including portable remote units with Radio Frequency (RF) receivers or transceivers capable of receiving command transmissions from a high power wireless network and/or RF tower or low power wireless system and/or handheld device. Upon receiving a user's activation signal from the wireless network, the key-fob will then emit an audible sound, activate a flashing light and/or activate various vehicle functions.

The present application is related and claims priority to previously filed provisional application serial No. 60/348,006, filed Jan. 11, 2002 entitled “Key Chain Location Device for a Wireless Keyless Entry Unit

### BACKGROUND OF THE INVENTION

1. Technical Field

Embodiments of the present invention relate to a device including portable remote units with Radio Frequency (RF) receivers or transceivers capable of receiving command transmissions from a high power wireless network and/or RF tower or other wireless system. Upon receiving a user's activation signal from the wireless network, the remote unit will then emit an audible sound, activate a flashing light and/or activate various vehicle functions.

2. Background Art

The importance of keys in society is prevalent everywhere. Keys start automobiles, unlock doors, and provide security. Recently there have been advancements in the concept of the key, such as keyless entry systems in automobiles. The notion is still the same, but instead of a crude metallic object, a remote control device is used to unlock the vehicle. Even so, a key is still required to operate the vehicle. The ability for one to recover a house, car, or safe key is crucial.

Currently there are several solutions to locating lost items such as a key or key chain. One example is a device, which is activated by an audible sound such as a clap or whistle, whereby the device emits an audible sound of its own. The problem with these devices is the tendency to be unintentionally activated from other external noises, such as car vibrations and music. Unintentional activation can prove dangerous while driving if suddenly the key-chain begins to beep loudly due to some obscure sound. Another shortcoming is if the difficulty in producing an appropriate activity.

Another example of a key location device is a system that incorporates a handheld remote control operating a low-power transmitter and four locator devices. The locator devices emit an audible sound when selected and activated by the handheld remote. The problem with this design is that it requires the remote to be present if one should lose their keys; therefore the range of the handheld remote limits this particular device.

Another key locator device or system of devices requires more than one key chain to operate. Each unit includes a button, which activates the other unit when pressed. When activated the device emits an audible sound and flashing light. Again this design is limited by the range of the activating unit and requires two units to be effective.

With regard to a remote unlocking feature, there exists a system that utilizes a satellite network to activate a computer-chip within the vehicle, which unlocks the vehicle doors. This technology although useful to an extent, is expensive and does not provide a solution to misplaced keys.

### DISCLOSURE OF THE INVENTION

Embodiments of the present invention relate to an electronic apparatus capable of initiating an audible sound when activated remotely via a high power wireless network, such as but not limited to, a RF tower and/or a low power transmission system, such as but not limited to a handheld device. The invention may also be capable of engaging the standard onboard technology of an automobile for various vehicle functions, such as but not limited to, the keyless entry feature, alarm, and engine start when signaled via the high power wireless network.

An example of engaging the keyless entry feature is if keys attached to the key-fob are locked in a vehicle. It then becomes possible for the user to activate the device via the high power wireless network and/or low power transmission system. The now activated device will then send an unlocking command to the current keyless entry system already present within the vehicle. The invention could also activate a variety of vehicle functions incorporating the technology currently present in the vehicle.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 displays a system for remotely activating the key-fob according to an embodiment of the present invention;

FIG. 2 is a device configuration incorporating the components necessary to emit an audible sound, activate a light source, and emit a command signal to activate the functions of a vehicle according to an embodiment of the present invention;

FIG. 3 is a device configuration incorporating the components necessary to emit an audible sound, and activate a light source according to an embodiment of the present invention;

FIG. 4 is a device configuration incorporating the components necessary to emit a command signal to activate the functions of a vehicle according to an embodiment of the present invention;

FIG. 5 is a first alternate device configuration incorporating the components necessary to emit a command signal to activate the functions of a vehicle, which could include additional components to emit an audible sound, and/or activate a light source according to an embodiment of the present invention;

FIG. 6 is a second alternate device configuration incorporating the components necessary to emit a command signal to activate the functions of a vehicle, which could include additional components to emit an audible sound, and/or activate a light source according to an embodiment of the present invention;

FIG. 7 is a third alternate device configuration incorporating the components necessary to emit a command signal to activate the functions of a vehicle, which could include additional components to emit an audible sound, and/or activate a light source according to an embodiment of the present invention;

FIG. 8 is an example of remotely activating the key-fob according to an embodiment of the present invention.

### DETAILED DESCRIPTION OF EMBODIMENTS OF THE INVENTION

The present invention overcomes the shortcomings of current key-fobs by combining a location feature with the remote unlocking feature in a portable unit. The key-fobs of the present invention are activated either by a high-power mobile wireless network or local low-power transmission. This approach provides excellent range of activation for both features and convenience. This design also provides a solution to the problem of lost keys and accidentally locking one's keys in an automobile.

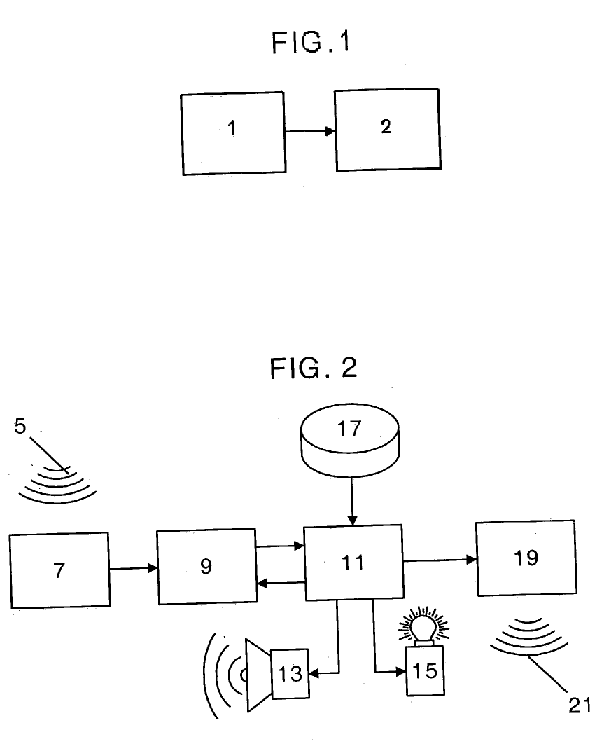

FIG. 1 illustrates the basic components necessary to activate the invention. A transmitter (1) which is capable of receiving a command signal indicative of a function and relaying that signal to the key-fob (3) which then performs the function. The function can include but is not limited to emitting an audible sound, activating a light source, unlocking a vehicle, starting a vehicle, and/or numerous functions of a vehicle which may be initiated electronically.

FIG. 2 illustrates a first configuration of devices and/or discrete components within the key-fob of one embodiment of the invention to function. A user interface is outlined (17) which may be a button, touch-pad, or any other means by which the operator can interface directly with a key-fob of the invention. This will also allow the user to manually operate the invention. The micro-controller (11) allows for component management, data interpretation and storage. The micro-controller may comprise other discrete devices such as a processor for data manipulation and memory such as Flash, Magnetic Random Access Memory (MRAM), Synchronized Dynamic Random Access Memory (SDRAM), and/or similar components for data storage. It is contemplated that the micro-controller may be a single semi-conductor component incorporating the necessary devices imbedded within. A transmitter (19), capable of transmitting a signal (21) to activate one or more vehicle functions is also shown. This is a component that is inherent in current automobile keyless entry system key-chains and may also include an encoder to encode the data transmission to the vehicle. The decoder (9) is displayed in conjunction with the micro-controller (11). Since the incoming signal representative of the selected function is encoded as an industry standard transmission format including but not limited to Post Office Code Standardization Advisory Group (POCSAG) code and/or FLEX code the decoder component is used to decode the incoming signal into usable data. The Radio Frequency (RF) receiver (7) is capable of receiving radio frequency signals (5) from a high power wireless network or low power transmission for operation. By example, this component is shown in conjunction with the decoder (9). Additional components include a device capable of emitting an audible sound (13) such as a speaker or buzzer and a light source (15) such as an LED. It is contemplated that components 7, 9, 11, and 19 be imbedded into one semi-conductor device capable of performing all the functions indicative of each component.

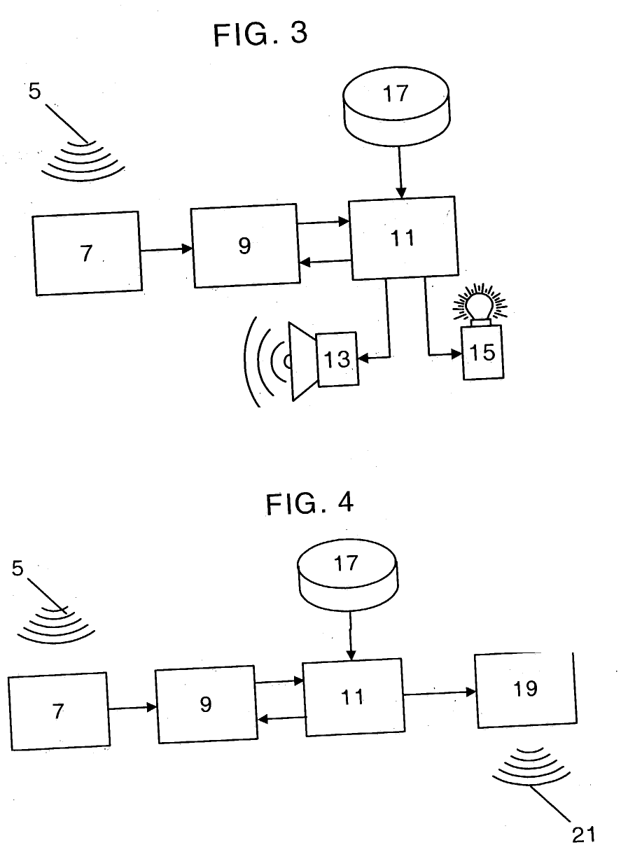

FIG. 3 demonstrates a second configuration of devices and/or discrete components for one embodiment of the invention to function. This embodiment includes the ability to emit an audible sound and activate a light source, but does not include the ability to activate various vehicle functions. A user interface is outlined (17) which may be a button, touch-pad, or any other means by which the operator can interface directly with the invention. This will also allow the user to manually operate the invention. This part is shown in conjunction with the micro-controller (11), which allows for component management, data interpretation and storage. A decoder (9) is displayed in conjunction with the micro-controller (11) and R.F. receiver (7). The decoder component (9) is used to decode the incoming signal into usable data. The RF receiver (7) is capable of receiving signals (5) from a wireless network and/or a low power transmission. Also in conjunction with the micro-controller (11) is a component capable of emitting an audible sound (13) and/or a light source (15).

FIG. 4 demonstrates a third configuration of devices and/or discrete components for an embodiment of the invention to function. This embodiment includes the ability to activate various vehicle functions, but does not include the ability to emit an audible sound and activate a light source. A user interface is outlined (17) which may be a button, touch-pad, or any other means by which the operator can interface directly with the invention. This will also allow the user to manually operate the invention. This part is shown in conjunction with the micro-controller (11), which allows for component management, data interpretation and storage. The micro-controller may comprise other discrete devices such as a processor for data manipulation and memory such as Flash, MRAM, SDRAM and/or similar components for data storage. It is contemplated that the micro-controller may be a single semi-conductor component incorporating the necessary devices imbedded within. A decoder (9) is displayed in conjunction with the micro-controller (11) and R.F. receiver (7). The decoder component (9) is used to decode the incoming signal into usable data for the invention to function. The RF receiver (7) is capable of receiving signals (5) from a wireless network and/or a low power transmission. A transmitter (19), capable of transmitting the necessary signal (21) to activate any numerous vehicle functions is also shown in connection with the microcontroller (11). A transmitter (19) is inherent in current automobile keyless entry system key-chains and may also include an encoder to encode the data transmission to the vehicle.

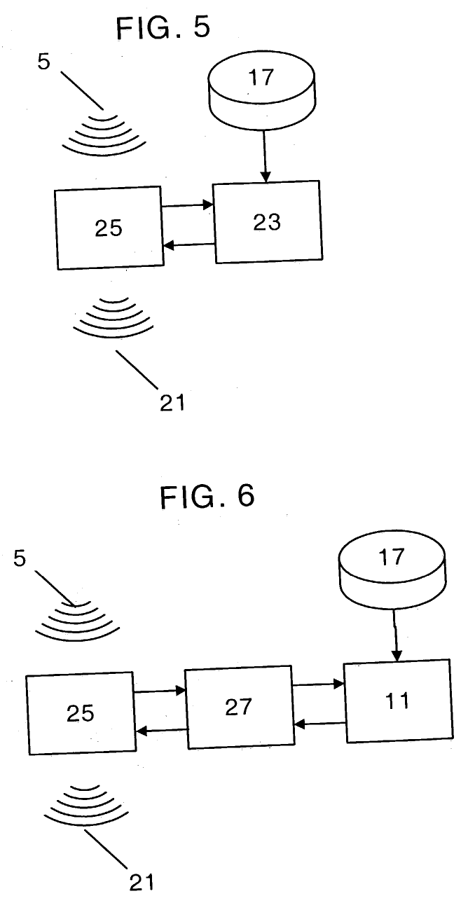

FIG. 5 illustrates a fourth configuration of devices and/or discrete components for an embodiment of the invention. This embodiment utilizes a transceiver (25) that is capable of receiving and sending signals, and a micro-controller (23) with the ability to decode and encode signals indicative of a selected function. A user interface is outlined (17) which may be a button, touch-pad, or any other means by which the operator can interface directly with the invention. The interface (17) also allows the user to manually operate the invention. The interface (17) for the embodiment of FIG. 5 is shown in with respect to the micro-controller (23) with integrated encoding and decoding features that allow for component management, data interpretation and storage, signal decoding, and signal encoding. The integrated micro-controller decoder/encoder (23) may comprise other discrete devices such, as a processor for data manipulation and memory such as Flash, MRAM, SDRAM and/or similar components for data storage. The single or multiple frequency transceiver (25) is capable of receiving signals (5) from a high power wireless network and/or a low power transmission. The Transceiver (25) is also capable of transmitting the necessary signal (21) to activate any numerous vehicle functions. It should be noted that a light source (15) and sound-emitting component (13) could easily, be integrated in this unit.

FIG. 6 illustrates a fifth configuration of devices and/or discrete components for an embodiment of the invention. This embodiment utilizes a single or multiple frequency transceiver (25) that is capable of receiving and sending signals; a micro-controller (11) that allows for component management, data interpretation and storage; and a. combination decoder/encoder component with the ability to decode and encode signals indicative of a selected function. A user interface is outlined (17) which may be a button, touch-pad, or any other means by which the operator can interface directly with the invention. The interface also allows the user to manually operate the invention. The interface for the embodiment of FIG. 6 is shown in with respect to the micro-controller (11). The micro-controller (11) may comprise other discrete devices such as a processor for data manipulation and memory such as Flash, MRAM, SDRAM and/or similar components for data storage. It is conceivable for the micro-controller to be a single semi-conductor component incorporating the necessary devices imbedded within. The single or multiple frequency transceiver (25) is capable of receiving signals (5) from a high power wireless network and/or a low power transmission. The Transceiver (25) is also capable of transmitting the necessary signal (21) to activate any numerous vehicle functions. It should be noted that a light source (15) and sound-emitting component (13) could easily be integrated in this unit.

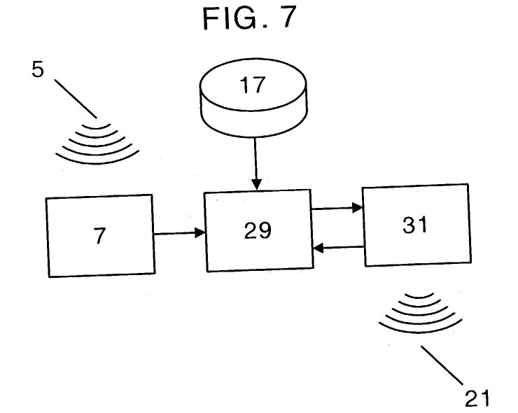

FIG. 7 illustrates a sixth configuration of devices and/or discrete components for an embodiment of the invention. This variation utilizes a RF Receiver (7), a transmitter with integrated encoder (31), and a micro-controller with integrated decoder (29). A user interface is outlined (17) which may be a button, touch-pad, or any other means by which the operator can interface directly with the invention. The interface also allows the user to manually operate the invention. The interface for the embodiment of FIG. 7 is shown in conjunction with the micro-controller with integrated decoder (29), which allows for component management, data interpretation, data storage, and also decodes an incoming signal indicative of a selected function into usable data for the invention to function. The RF receiver (7) is capable of receiving signals (5) from a wireless network and/or a low power transmission. The transmitter with integrated encoder (31), capable of encoding and transmitting'the necessary signal (21) to activate any numerous vehicle functions is also shown in connection with the micro-controller (11). The transmitter is inherent in some automobile keyless entry system key-chains and may also include an encoder to encode the data transmission to the vehicle. It should be noted that a light source (15) and sound-emitting component (13) could easily be integrated in this unit.

The following is one particular example of the various parts that could be used to build the invention. These are only one example of possible components those of ordinary skill in the art will understand that there are a wide variety of alternate parts that could be used to perform similar function(s) in substantially the same way and with substantially the same results.

Micro Controller (11)—Atmel part number Attiny28L

Transmitter (19)—Texas Instruments part number TRF4400

Decoder (9)—Nippon Precision Circuits Inc. part number 8212BM

R.F. Receiver (7)—RF Micro Devices RF2917

Transceiver (25)—Texas Instruments part number TRF4400PW

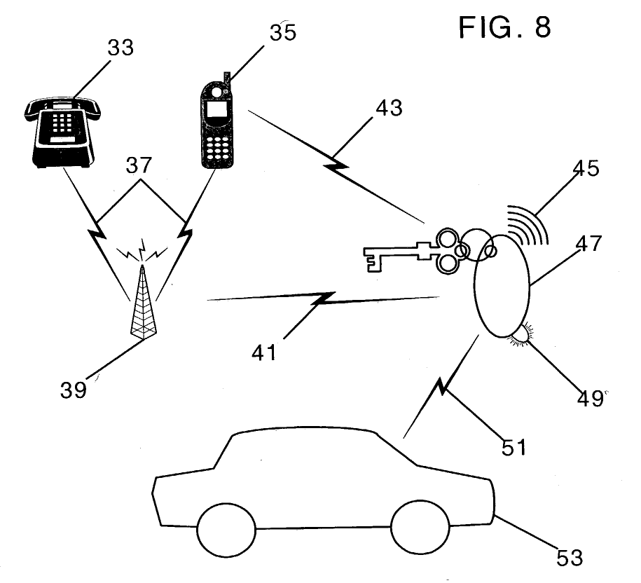

FIG. 8 illustrates a system for operation of a key-fob configured according to an embodiment of the invention. Operation begins with an initial command signal (37) being sent to a high power wireless network (39) for transmission to the key-fob (47) by use of a telephone (33), and/or a handheld wireless device (35) such as, but not limited to, as cell-phone, pager, or other various handheld technology. Another initial command signal (43) may alternately be sent directly to the key-fob from a handheld wireless device (35). The invention could utilize any range of power frequencies for successful operation of the key-fob (47). Once the relayed command signal (41) or initial command signal (43) has been received by the key-fob, the key-fob will then perform a function indicated by the received signal (41 or 43). This could include emitting an audible sound (45), activating a light source (49), and/or transmitting a vehicle function command (51) to a vehicle (53).

One particular example of the invention's operation is the following: An incoming transmission signal (5) is received by the invention through an RF receiver component or similar device (7). The signal is then carried to the decoder or similar device (9) where the signal is converted to usable data. The decoder (9) is in communication with the micro-controller (11). The micro-controller is responsible for, but not limited to, data interpretation and storage, decoding verification, operator interface management, and component management. Depending on the incoming signal (5) received from the remote transmitter (35 or 39), the micro-controller (11) will activate the appropriate function. Functions include, but are not limited to, emitting an audible sound (13), activating a light source (15), and/or activating the transmitter (19) for various vehicle functions. If the later is selected, the signal is sent to a component, which encodes the signal indicative of a selected function for transmission by the transmitter (19, 25, 31). This vehicle function signal then activates the desired operation such as, but not limited to, unlocking doors, staring the engine, and activating an alarm.

The embodiments and examples set forth herein are presented in order to best explain the present invention and its practical application, and to thereby enable those of ordinary skill in the art to make and use the invention. However, those of ordinary skill in the art will recognize that the description and examples provided here are presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A system for remotely activating a remote entry key-fob, the system comprising:
a remote entry key-fob configured to receive a signal and execute a function indicated by the signal;
a transmitter configured to receive a first command representative of the function to be performed by the key-fob and to transmit the signal to the key-fob.

2. The system of claim 1, wherein the transmitter comprises a wireless network configured to receive a second command representative of the function to be performed by the key-fob and to transmit the first command representative of the function.

3. The system of claim 1, wherein the transmitter is configured to provide a low power transmission to the key-fob.

4. The system of claim 1, wherein the transmitter is configured to provide a high power transmission to the key-fob.

5. The system of claim 1, wherein the key-fob is configured to emit an audible sound upon receipt of the signal representative of the function.

6. The system of claim 1, wherein the key-fob is configured to activate a light source upon receipt of the signal representative of the function.

7. The system of claim 1, wherein the key-fob is configured to emit a command signal to activate a function of a vehicle.

8. The system of claim 6, wherein the key-fob is configured to emit an unlock command signal to the vehicle.

9. The system of claim 6, wherein the key-fob is configured to emit an engine start command signal to the vehicle.

10. A system for remotely activating a remote entry key-fob for a vehicle, the system comprising:
a remote entry key-fob configured to receive a signal, execute” a function indicated by the signal, and remotely activate a function of the vehicle;
a transmitter configured to receive a first command representative of the function to be performed by the key-fob and to transmit the signal to the key-fob.

11. The system of claim 10, wherein the transmitter comprises a wireless network configured to receive a second command representative of the function to be performed by the key-fob and to transmit the first command representative of the function.

12. A method of remote activating a vehicle function, the method comprising:
receiving a first command representative of a function to be performed by a key-fob;
transmitting a signal to the key-fob indicative of the function to be performed;
receiving the signal at the key-fob; and
performing the function through the key-fob.

13. The method of activation of claim 12 wherein receiving a first command comprises receiving from a RF tower.

14. The method of activation of claim 12 wherein receiving a first command comprises receiving from a handheld device.

15. The method of activation of claim 12 wherein transmitting a signal to the key-fob comprises transmitting from a RF tower.

16. The method of activation of claim 12 wherein transmitting a signal to the key-fob comprises transmitting from a handheld device.

17. The method of activation of claim 12 wherein performing the function through the key-fob comprises emitting an audible sound, activating a light source, transmitting a vehicle unlock command, activating/deactivating a vehicle alarm, starting a vehicle, or any combination of the functions described.

18. A method of remote activating a vehicle function, the method comprising:
receiving a first command representative of a function to be performed by a key-fob;
transmitting a signal to the key-fob indicative of the function to be performed;
receiving the signal at the key-fob; and
transmitting a second signal from the key-fob to the vehicle to activate a vehicle function.

19. The method of activation of claim 18 wherein receiving a first command comprises receiving from a RF tower.

20. The method of activation of claim 18 wherein receiving a first command comprises receiving from a handheld device.

21. The method of activation of claim 18 wherein transmitting a signal to the key-fob comprises transmitting from a RF tower.

22. The method of activation of claim 18 wherein transmitting a signal to the key-fob comprises transmitting from a handheld device.

23. The method of activation of claim 18 wherein to activate a vehicle function comprises unlocking a vehicle, activating/deactivating a vehicle alarm, starting a vehicle, opening the doors of a vehicle, opening the trunk of a vehicle, or any combination of the functions described.
